(19) United States
(12) Patent Application Publication
(10) Pub. No.: US 2006/0151007 A1
(43) Pub. Date: Jul. 13, 2006

(54) Workpiece processing using ozone gas and chelating agents

(76) Inventor: Eric J. Bergman, Kalispell, MT (US)

Correspondence Address: PERKINS COIE LLP/SEMITOOL, PO BOX 1208, SEATTLE, WA, 98111-1208, US

(21) Appl. No.: 11/371,559

(22) Filed: Mar. 9, 2006

Related U.S. Application Data
(63) Continuation-in-part of application No. 09/925,884, filed on Aug. 6, 2001.
Application No. 09/925,884 is a continuation-in-part of application No. 09/621,028, filed on Jul. 21, 2000, now Pat. No. 6,869,487.
Application No. 09/621,028 is a continuation-in-part of application No. PCT/US99/08516, filed on Apr. 16, 1999.
Application No. PCT/US99/08516 is a continuation-in-part of application No. 09/061,318, filed on Apr. 16, 1998, now abandoned.
Application No. 09/061,318 is a continuation-in-part of application No. 08/853,659, filed on May 9, 1997, now Pat. No. 5,925,522.

(51) Int. Cl. B08B 3/00

(52) U.S. Cl. 134/26; 134/94.1

(57) ABSTRACT

In systems and methods for cleaning a wafer having an oxide on a surface of the wafer, an aqueous liquid including a chelating agent is applied onto the wafer, while the wafer is also contacted by ozone gas. The ozone readily oxidizes the contaminants in the presence of the aqueous liquid. The chelating agent helps to remove metal contamination from the wafer, without the need for an acid such as hydrofluoric or hydrochloric acid. Etching of the oxide layer is accordingly reduced. The wafer can be effectively cleaned using aqueous liquid and ozone, while largely preserving the oxide layer needed for certain types of micro-scale devices formed on the wafer.

This application is a Continuation-in-Part of U.S. patent application Ser. No. 09/925,884, filed Aug. 6, 2001 and now pending, which is a Continuation-in-Part of application Ser. No. 09/621,028, filed Jul. 21, 2000, now U.S. Pat. No. 6,869,487, which is a Continuation-in-Part and U.S. National Phase of International Application No. PCT/US99/08516, filed Apr. 16, 1999, (designating the United States and published in English), which is a Continuation-in-Part of Ser. No. 09/061,318, filed Apr. 16, 1998, now abandoned, which is a Continuation-in-Part of: Ser. No. 08/853,649, filed May 9,1997, now U.S. Pat. No. 6,240,933. Priority to each of these application is claimed. The above listed applications are also incorporated herein by reference.

### BACKGROUND OF THE INVENTION

Microelectronic semiconductor devices are essential in modern day life. These devices are used in electronic products, computers, automobiles, cell phones, and a vast array of communications, medical, industrial, military, and office products and equipment. Microelectronic semiconductor devices are manufactured from semiconductor wafers. Typically, these devices may be just fractions of a micron, with thousands of devices manufactured on a single wafer. Correspondingly, microelectronic devices are highly susceptible to performance degradation or failure due to contamination by even microscopic particles, films and process residues.

Manufacturing microelectronic devices requires a large number of steps, with layers of materials selectively applied and removed from the wafer. The wafer usually must be cleaned between various steps, to insure that any remaining process chemicals, residues, films or particles (collectively referred to here as contaminants) are removed. Consequently, wafer cleaning is a critical step in the manufacturing process. Obtaining the very high levels of cleanliness required in microelectronic device manufacturing presents various challenges. The wafer, which is typically highly pure silicon, generally has layers, films or patterns of other materials, such as metals, insulators, organics, and oxides. As a result, the cleaning processes used must be able to achieve high levels of cleanliness by removing contaminants, but without also excessively removing these other materials. Oxide layers, such as silicon dioxide, are one of the basic materials used in microelectronic devices. They are commonly used as dielectric layers, because they are insulators. They are major components of metal-oxide-semiconductor (MOS) devices. These devices have many advantages and are widely used.

For many years, wafers were cleaned in typically three or four separate steps using strong acids, such as sulfuric acid, and using strong caustic solutions, such as mixtures of hydrogen peroxide or ammonium hydroxide. Organic solvents have also been used with wafers having metal films. These methods had certain disadvantages, including the high cost of the process chemicals, the relatively long time required to get wafers through the various cleaning steps, high consumption of water due to the need for extensive rinsing between chemical steps, and high disposal costs. As a result, extensive research and development efforts focused on finding better wafer cleaning techniques.

Several years ago, the Inventor developed a revolutionary new process for cleaning wafers using ozone gas and heated water (or water vapor). This process, described in its basic form in Applications listed in paragraph 0001 above has proven to be highly effective in cleaning contamination and organic films, while avoiding many of the disadvantages of the traditional cleaning methods. More recently, the semiconductor manufacturing industry has acknowledged the advantages of the ozone gas and heated water process. Some of the advantages of this ozone and heated water process are that it is fast, requires no expensive and toxic liquid acids or caustics, and operates effectively as a spray process, which greatly reduces water consumption and space requirements.

In one form that has proven to be highly advantageous for removing metals, the ozone and heated water process is used with hydrochloric (HCl) and/or hydrofluoric acid (HF). While providing a huge improvement over earlier cleaning technologies having metal removal capability, some forms of this process can cause significant loss of oxide layers from wafers. Too much oxide layer loss can degrade certain types of semiconductor device structures. Accordingly, there is a need for an improved cleaning process which can remove metals while also reducing oxide loss.

### SUMMARY OF THE INVENTION

Following additional research and development, the Inventor has overcome the oxide loss problem. As a result, the advantageous heated water and ozone process can now be used to clean even more types of wafers, without the problems resulting from oxide loss. The multifaceted improvements offered by the heated water and ozone process can now even be successfully used in manufacturing state of the art microelectronic devices which are sensitive to oxide loss.

In one aspect of the invention, in a wafer cleaning method, one or more wafers are placed into a processing chamber. An aqueous liquid including a chelating agent onto the wafer is applied onto the wafer. Ozone gas is provided in the processing chamber. The ozone gas oxidizes contaminants on the wafer, to clean the wafer. The chelating agent may assist in removing and/or binding with metal contaminants. As use of acids such as HF and/or HCl are not needed for metal removal, loss of oxide is reduced. Metal films or contaminants on wafers having devices that may be affected by oxide loss can be efficiently and effectively removed via the heated water and ozone process, with no adverse affects.

In another separate aspect of the invention, a wafer cleaning apparatus or system includes a wafer holder in the chamber, for holding one or more wafers. Liquid outlets in the chamber are positioned to apply liquid onto at least one surface of a wafer supported by the wafer holder. A source of aqueous liquid, such as a storage tank, supplies liquid to the liquid outlets. The aqueous liquid includes a chelating agent. A heater heats the aqueous liquid. An ozone gas source, such as an ozone generator, supplies ozone gas directly or indirectly into the chamber. The wafer holder optionally spins the wafer. The ozone gas oxidizes contaminants on the wafer in the presence of the aqueous liquid, to clean the wafer. The chelating agent may help to remove metal films and/or chemically bind with metal contamination. There is little or no loss of oxide. The apparatus can efficiently clean many different types of wafers, including wafers having devices that may be degraded or damaged by oxide loss.

The invention resides as well in sub-combinations of the features, components, steps, and subsystems shown and described. The optional steps described in one embodiment or shown in one drawing may apply equally to any other embodiment or drawing.

### BRIEF DESCRIPTION OF THE DRAWINGS

In the drawings, wherein the same reference number indicates the same element in each of the Figures:

FIG. 1 is a diagram of a system for cleaning a workpiece, such as a semiconductor wafer, with ozone injected or bubbled into the liquid.

FIG. 2 is a diagram of a system for cleaning a batch of workpieces.

FIG. 3 is a diagram of a system for cleaning a workpiece using ozone gas and a liquid, with the ozone supplied into the processing chamber, rather than into the liquid as shown in FIG. 1.

FIG. 4 is a diagram of a system for cleaning a workpiece using a vapor and ozone gas.

FIG. 5 is a diagram of a system similar to the system of FIG. 3, with liquid applied to the workpiece from a nozzle on a swing arm, optionally in the form of a jet.

While showing preferred designs, the drawings include elements which may or may not be essential to the invention. The elements essential to the invention are set forth in the claims. Thus, the drawings include both essential and non-essential elements.

### DETAILED DESCRIPTION OF THE DRAWINGS

The terms workpiece, wafer or semiconductor wafer are defined here to include any flat media or article, including a semiconductor wafer or other wafer or substrate, glass, mask, optical, disk, thin film or memory media, flat panel displays, MEMs substrates, and any other substrates upon which microelectronic circuits or components, data storage elements, and/or micro-mechanical, or micro-electromechanical elements are or can be formed.

The term chelating agent means an organic substance having molecules that form bonds with metals and metal ions.

In a method for cleaning a wafer having an oxide area or layer, an aqueous liquid including a chelating agent is applied onto the wafer, while the wafer is also contacted by ozone gas. The aqueous liquid helps to make the chemical bonds of the contaminant susceptible to oxidation by the ozone. The ozone readily oxidizes the contaminants in the presence of the liquid. The liquid also provides a medium for carrying away oxidized contaminants or byproducts. Addition of the chelating agent allows for removal of metal contaminants without substantially removing an oxide layer, as may occur when acids are included in the liquid, for removal of metals. High pH solutions can remove particles with minimal removal of oxide layers. However, with solutions having a pH above about 7, metals tend to plate out on the wafer. The chelating agent bonds or attaches with the metals, largely preventing them from plating out on the wafer. As used here, the term without substantial oxide loss means less than 5, 4, 2, or 1 angstrom of loss of oxide layer thickness. In a typical process run for 5-10 minutes, an oxide layer loss of about 0.2 angstroms/minute may occur, resulting in a total oxide layer loss of 1-2 angstroms.

The method may be performed in a chamber at sub-ambient temperatures (for example 0-20° C.), at ambient temperatures (20° C.), or at higher temperatures. In general, the liquid includes de-ionized water and is heated to 25° C. or 30° C.-99° C. The wafer may be separately heated by contact or radiant heating elements in the chamber.

The chamber may be at ambient pressure, since neither above or below ambient pressures are needed. Depending on the liquid used, the contamination to be removed, or other factors, above or below ambient chamber pressures may be used. For example, chamber pressure may be increased over ambient pressure by, e.g., 10%, 20%, 30%, or 50-100% or 200%, or higher. Where above ambient pressures are used, and the liquid includes water, liquid temperatures above 99° C. may correspondingly be used.

The method may be performed in a single wafer mode, by processing a single wafer within a process chamber. The method may also be performed in a group or batch mode, with multiple wafers processed simultaneously within a single batch processing chamber. In general, it is helpful to spin the wafers during processing. Spinning helps to distribute the liquid on the wafer surface, and also helps to maintain a flow of liquid off the edges of the wafer, via centrifugal force. The flow of liquid carries away oxidized contaminants, and tends to maintain a supply of fresh liquid on the wafer. Spinning may also-be used to form the liquid into a thin layer on the wafer. The flow rate of liquid onto the wafer may also be controlled, optionally along with spin speed, and/or use of surfactants, to establish and maintain a thin layer of liquid on the wafer. Ozone gas in the chamber can then more easily diffuse through the layer of liquid to the wafer surface, to oxidize contaminants on the surface. However, the present methods may also be performed without spinning. The orientation of the wafer(s) during processing, or the orientation of the spin axis (if spinning is used) is not essential. Wafer orientation may be selected on the basis of the particular machine used to perform the methods.

Various chelating agents may be used, including triethanolamine, diethlenetriaminopentaacetic acid, 1,2-cyclohexanediaminotetraacetic acid, hydrozyethidiphosphonic acid, diethylenetriaminepenta, ethylenediaminetetracetic acid, and pyridinone acetic acid. The chelating agent is typically provided at a concentration of about 1-100 ppm, and more often in a range of about 5-20 ppm. Additives, such as hydrogen peroxide, ammonium hydroxide, ammonium fluoride, tetramethyl ammonium hydroxide, and choline. The chelating agent enhances the cleaning by promoting the removal of metallic contaminants, with the ozone oxidizing and removing organic contaminants. Other additives may also be used to further enhance the cleaning, for example, the use of ammonium hydroxide to improve particle removal along with the ozone and chelating agent.

The liquid may be applied by spraying, aerosolizing, vaporizing, flowing, streaming, jetting, condensing, or immersion. The liquid may be applied to one or both sides of the wafer. In a condensing method, a vapor or steam is provided into the chamber. The vapor then condenses on the wafer. The liquid may be applied to either an up-facing side of the wafer, or to a down-facing side of the wafer, or to both. The supply of liquid, gases, and/or vapor may be continuous or pulsed. Process times will vary depending on the contamination to be removed, process temperatures, and other parameters. The invention contemplates use of ozone gas and an aqueous liquid including a chelating agent, regardless of how each of these elements is provided into the chamber.

The ozone gas may be provided as dry gas sprayed, jetted, pumped or otherwise introduced into the chamber. The ozone gas may also be mixed into or entrained with the liquid. In this design, some of the ozone may be dissolved into the gas, with other fractions of the ozone gas entrained as gas bubbles in the liquid. A combination of dry gas injection and injection into liquid may also be used.

The process is effective for removing various types of contaminants and films, such as photoresist, post etch residue, and other organic substances. The form of the oxide areas on the wafer is generally not important as the wafer is cleaned with little or no removal of the oxide in any areas. Following the cleaning process, the wafer may be dried directly. Alternatively, in some applications, the wafer may be rinsed with water or a water solution, and then dried.

The drawings show representative examples of systems that may be used to clean wafers. Dotted lines in the drawings indicate optional elements that may be omitted. One or more of the systems shown in the Figures may be used in an automated processing machine, wherein wafers are loaded and unloaded via a robot, such as described in U.S. Pat. Nos. 6,900,132 and 6,723,174.

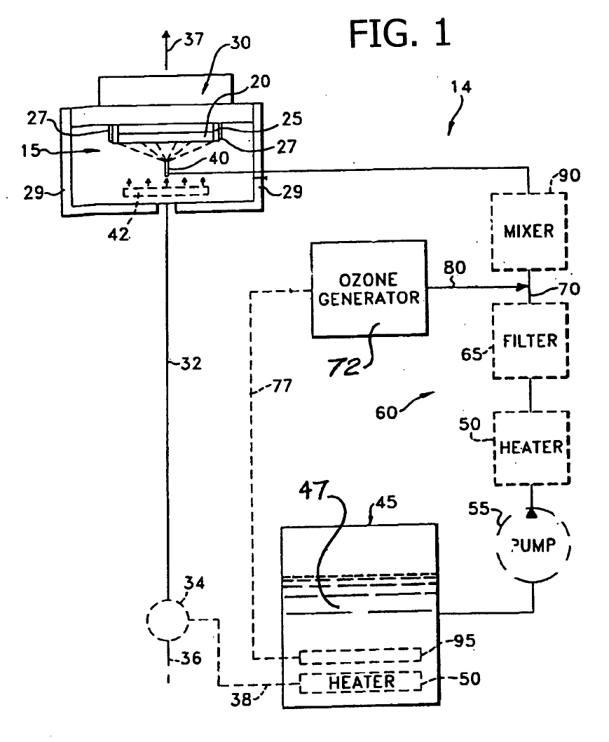

Turning now to FIG. 1, in a single workpiece processing or cleaning system 14, a wafer or workpiece 20 is supported within a processing chamber 15, in this case, on a rotor assembly 30. A chamber door closes off or optionally also seals the chamber 15. The rotor assembly 30, if used, spins the workpiece 20 about a spin axis 37 during and/or after processing with ozone and an aqueous liquid, typically deionized water. The spin axis 37 is preferably vertical, although it may alternatively have other orientations. Alternatively, a stationary fixture may be used in the chamber 15 for non-spinning methods. The wafer 20 may be secured to the rotor assembly 30 using mechanical elements such as fingers, pins, levers, cams, etc.

If the volume of the processing chamber 15 is minimized, ozone gas consumption may be reduced. In a single wafer processor, typical chamber volumes may range from about 3-10, 4-8 or 5-6 liters. One or more outlets or nozzles 40 in the processing chamber 15, apply liquid onto the workpiece or wafer 20. In this design, the liquid is applied by a spray or stream of ozone gas and liquid onto the workpiece 20. The spray may be directed to the upper or lower surface of the workpiece 20, or both.

A reservoir 45 holds the aqueous liquid 47 containing a chelating agent. The concentration of the chelating agent is generally in the range of 1-100 ppm. The reservoir 45 may be connected to the input of a pump 55. The pump 55, if used, pumps the liquid 47 under pressure through a plumbing line 60, to supply to the nozzles 40. While use of a reservoir 45 is preferred, any liquid source may be used, including a pipeline connected to a separate external liquid source.

One or more heaters 50 in the liquid flow path may be used to heat the liquid. An in-line heater, or a tank heater, or both, may be used, as shown in FIG. 1. For sub-ambient applications, the heaters are replaced with chillers. For processes at ambient or room temperatures, the heater 50 can be omitted. The liquid flow path 60 may optionally include a filter 65 to filter out microscopic contaminants from the liquid.

In FIG. 1, ozone gas is generated by an ozone generator 72 and is supplied along via supply line 80, to the liquid flow line 70. A gas/liquid static or active mixer 90 may optionally be used to mix the ozone gas with the liquid. The process liquid and ozone gas are provided to the nozzles 40. The nozzles 40 spray or otherwise apply the liquid onto the surface(s) of the workpiece 20. Ozone is released from the liquid into the processing chamber 15. Consequently, an ozone gas environment may form in the chamber. As an alternative to mixing, the ozone may be entrained in the liquid, before the liquid is applied onto the workpiece 20.

At least some of the ozone gas is transported to the surface of the workpiece with the liquid. Water used as the liquid helps to weaken the chemical bonds of the molecules of the contaminant or film, due to the polarity of the water molecule. This hydrolization effect renders the chemical bonds susceptible to cleavage and oxidation by the ozone gas. The contaminant is consequently oxidized and removed via chemical reactions. The liquid may optionally be forcefully sprayed or jetted onto the workpiece, to physically remove the contaminant as well. Ozone gas in the chamber may also diffuse through any liquid layer on the workpiece. A thin liquid layer may be created on the wafer surface by rotating the workpiece, by controlling the flow rate of liquid, and/or by adding a surfactant to the liquid. If the thickness of the liquid layer is controlled and maintained sufficiently thin, significant amounts of ozone gas in the chamber may diffuse through the layer. The diffusing ozone may also act to oxidize contaminants on the workpiece. The chelating agent removes metal films or metal contamination (e.g., metal particles). The loss of oxide on the wafer associated with use of acids such as HF and/or HCl is avoided. In certain applications, some amounts of HF and/or HCl (or other acids) may be used along with a chelating agent.

To further concentrate the ozone in the liquid 47, an output line 77 of the ozone generator 72 may supply ozone to a dispersion unit 95 in the reservoir 45. The dispersion unit 95 provides a dispersed flow of ozone through the liquid before injection of the ozone gas into the fluid path 60. The dispersion unit 95 may be omitted, with ozone simply bubbled into the reservoir.

In the design shown FIG. 1, used liquid in the processing chamber 15 is optionally collected and drained via a fluid line 32 to a valve 34. The valve 34 may be operated to provide the spent liquid to either a drain outlet 36 or back to the reservoir 45 via a recycle line 38. Repeated cycling of the process liquid through the system and back to the reservoir 45 assists in elevating the ozone concentration in the liquid through repeated injection and/or dispersion. The spent liquid may alternatively be directed from the processing chamber 15 to a waste drain. The workpieces may optionally be heated directly, via optional heating elements 27, or via a chamber heater 29 for heating the chamber and indirectly heating the workpiece 20.

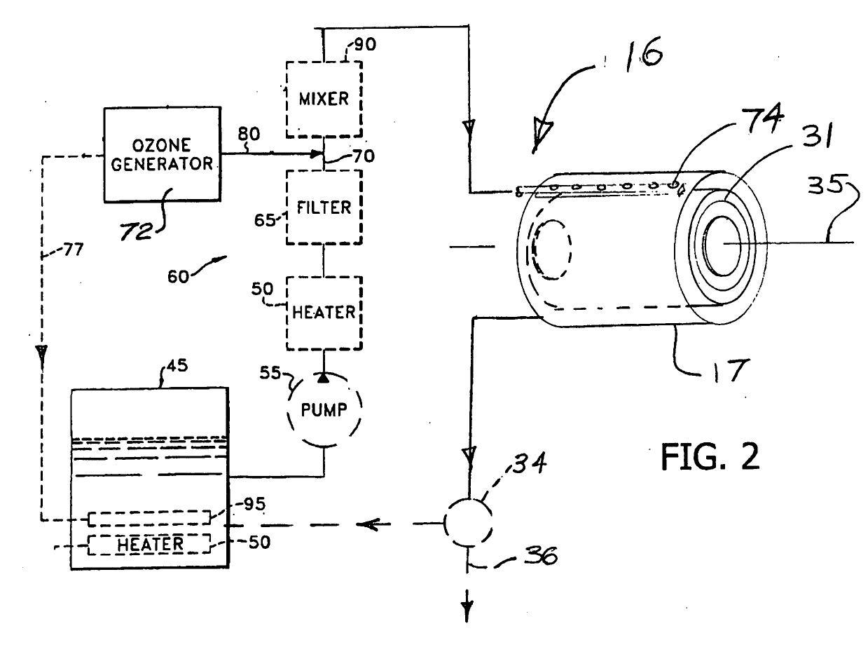

FIG. 2 shows a batch processing system 16 similar to single wafer system 14 shown in FIG. 1. In the system 16, a batch rotor 31 is enclosed within a process chamber 17 and spins about a spin axis 35. The orientation of spin axis 35 may vary, as it does not substantially affect operation of the cleaning process. The axis 35 may be near horizontal in some automated systems, to better facilitate loading and unloading of the rotor.

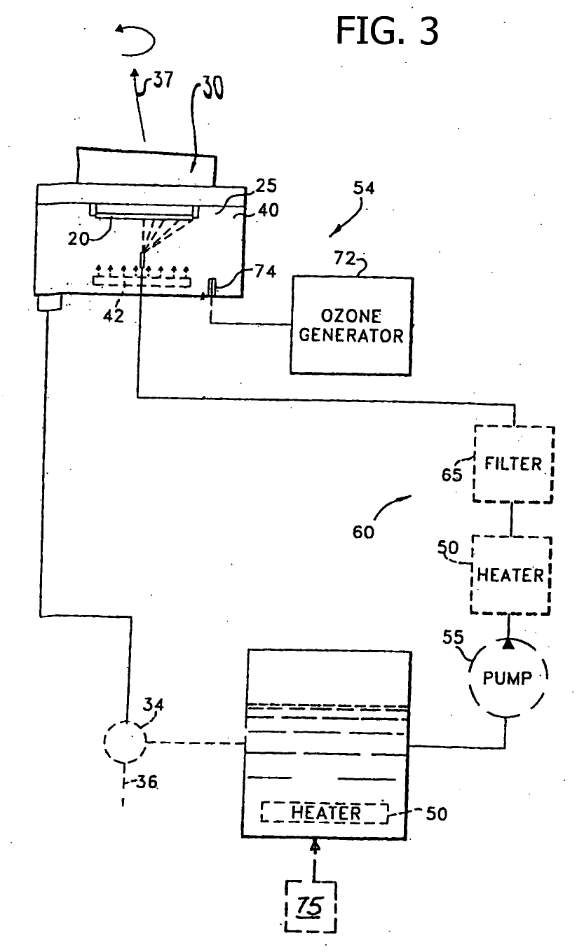

Turning to FIG. 3, in an alternative system 54, one or more nozzles 74 or openings within the processing chamber 15 deliver ozone from ozone generator 72 directly into the chamber (as a dry gas not mixed with any liquid). Additional ozone may also optionally be injected into the fluid path 60. The chamber may hold a single wafer or a batch of wafers. The system of FIG. 3 may otherwise the same as the systems of FIGS. 1 or 2 described above.

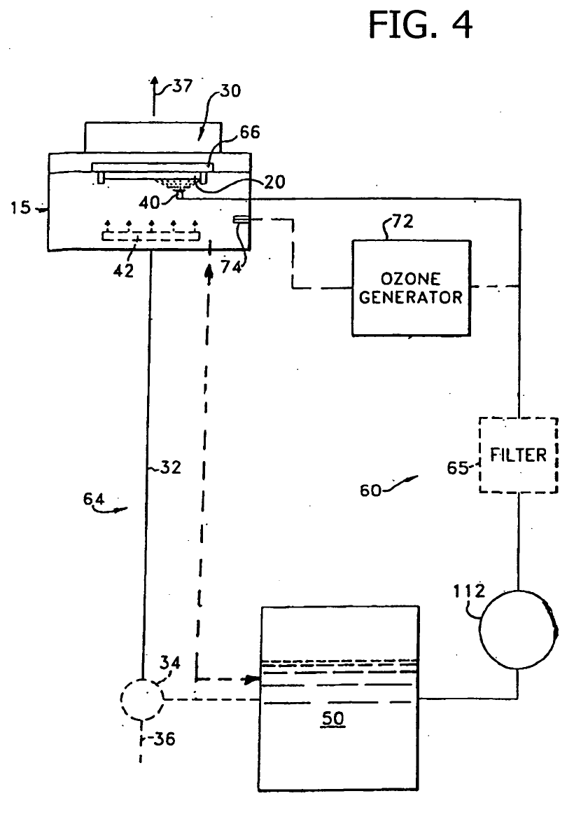

Referring to FIG. 4, in another system 64, a liquid vaporizer 112 supplies liquid vapor into the processing chamber 15. The chamber 15 is preferably sealed to form a pressurized atmosphere around the workpiece 20. Ozone may be directly injected into the processing chamber 15 as shown, and/or may be injected into the vapor supply pipe. With this design, workpiece surface temperatures can exceed 100° C., further accelerating the chemical reactions which clean the workpiece. While FIGS. 3 and 4 show the liquid and ozone delivered via separate nozzles 40, 74, they may also be delivered from the same nozzles, using appropriate valves.

A temperature-controlled surface or plate 66, as shown in FIG. 4, in contact with the workpiece may be provided to act as a heat sink, to maintain condensation of vapor on the workpiece. Alternatively, a stream of liquid at a temperature below the vapor condensation temperature may be delivered to the one side of a wafer 20, while vapor and ozone are delivered to the process chamber and the vapor condenses on the other side of the wafer. The wafer may be rotated to promote uniform distribution of the boundary layer, as well as to help to define the thickness of the boundary layer through centrifugal force. Rotation, however, is not a requirement.

An ultra-violet or infrared lamp 42, as shown in FIGS. 1 and 3-5, is optionally used in any of the designs described above, to irradiate the surface of the workpiece 20 during processing, and enhance the reaction kinetics. Megasonic or ultrasonic nozzles may also be used.

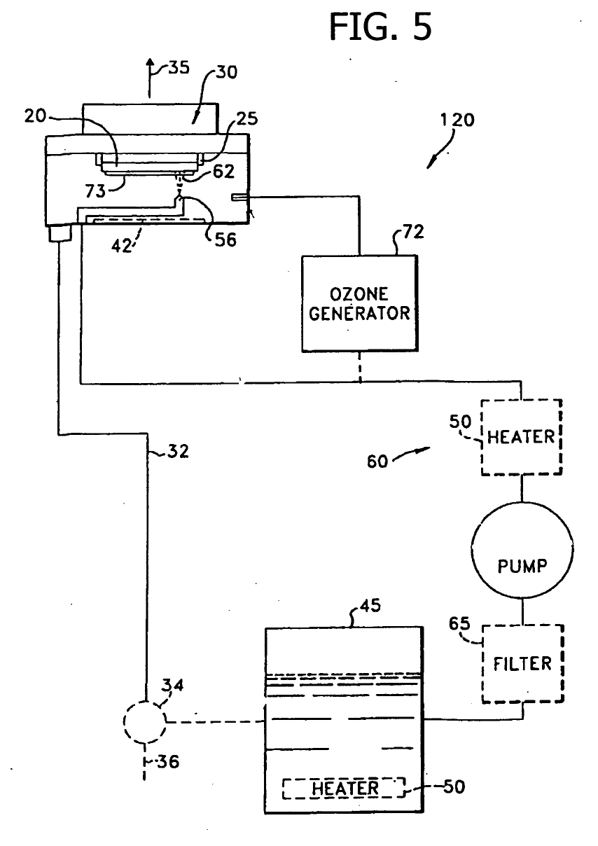

Referring to FIG. 5, another alternative system 120 is similar to the system 54 shown in FIG. 3, except that the system 120 does not use the spray nozzles 40. Rather one or more jet nozzles 56 are used to form a high pressure jet 62 of liquid. The liquid formed into the high pressure jet 62 penetrates through any layer 73 of liquid on the workpiece surface and impinges on the workpiece surface with much more kinetic energy than in conventional spray processes. The increased kinetic energy of the jet physically dislodges and removes contaminants. Unlike conventional fluid spray systems, few, if any, droplets are formed. Rather, a concentrated jet or beam of liquid impacts on a small spot on the workpiece 20.

Thus, while several embodiments have been shown and described, various changes and substitutions may of course be made, without departing from the spirit and scope of the invention. The invention, therefore, should not be limited, except by the following claims, and their equivalents.

1. A method for cleaning one or more workpieces comprising:
placing the workpiece into a processing chamber, with an oxide layer on at least part of the workpiece;
introducing an aqueous liquid including a chelating agent onto the workpiece;
introducing ozone into the processing chamber;
with the ozone cleaning oxidizable contaminants from the workpiece, and with the chelating agent cleaning metal contaminants from the workpiece.

2. The method of claim 1 wherein the ozone is introduced into the processing chamber as a dry gas.

3. The method of claim 1 wherein the liquid is heated to a temperature of 30-95° C.

4. The method of claim 1 wherein the liquid is substantially free of hydrofluoric or hydrochloric acid.

5. The method of claim 1 wherein the workpiece comprises a silicon wafer, and the contaminant comprises photoresist.

6. The method of claim 1 further comprising the step of rotating the workpiece within the processing chamber.

7. The method of claim 1 wherein the ozone is entrained in the liquid before the liquid is introduced onto the workpiece.

8. The method of claim 1 wherein the liquid and the ozone are introduced separately into the processing chamber.

9. The method of claim 1 wherein the liquid is sprayed onto the workpiece.

10. The method of claim 1 with the liquid further comprising an additive selected from the group consisting of hydrogen peroxide, ammonium hydroxide, ammonium fluoride, tetramethyl ammonium hydroxide, and choline.

11. The method of claim 1 further comprising rotating a batch of workpieces in the process chamber.

12. The method of claim 1 where the chelating agent comprises a member selected from the group consisting of triethanolamine, diethlenetriaminopentaacetic acid, 1,2-cyclohexanediaminotetraacetic acid, hydrozyethidiphosphonic acid. Dethylenetriaminepenta, ethylenediaminetetracetic acid, and pyridinone acetic acid.

13. The method of claim 12 with the chelating agent having a concentration in the liquid of from 1-100 ppm.

14. A method for processing one or more workpieces having an oxide layer, comprising:
heating a liquid including de-ionized water and a chelating agent;
forming a layer of the heated liquid on the surface of the workpiece; and
contacting the surface of the workpiece with ozone gas in the layer of heated liquid, with the ozone chemically reacting with an oxidizable contaminant at the surface of the workpiece, and with the chelating agent chemically reacting with a metal contaminant, to process the workpiece.

15. The method of claim 14 further including placing the workpiece into a chamber and pressurizing the chamber.

16. The method of claim 14 further including spraying the liquid onto the surface of the workpiece and rotating the workpiece.

17. The method of claim 14 further comprising introducing sonic energy into the liquid.

18. The method of claim 14 further comprising irradiating the workpiece with ultra-violet or infra-red light.

19. The method of claim 14 wherein oxide loss is less than 10 angstroms.

20. A method for cleaning one or more workpieces having an oxide layer on a surface of the workpiece, comprising:
placing the workpiece into a chamber;
heating a liquid including de-ionized water, ammonium hydroxide and a chelating agent;
forming a layer of the heated liquid on the surface of the workpiece; and
providing ozone gas into the chamber, with the ozone gas chemically reacting with a contaminant at the surface of the workpiece, and with the chelating agent chemically reacting with a metal contaminant, to process the workpiece, and with the oxide layer thickness remaining substantially unchanged.

21. An apparatus for cleaning a workpiece comprising:
a chamber;
a workpiece holder in the chamber;
liquid outlets in the chamber positioned to apply liquid onto at least one surface of a workpiece supported by the workpiece holder;
a source of aqueous liquid connecting with the liquid outlets, with the aqueous liquid including a chelating agent;
a heater for heating the aqueous liquid; and
a source of ozone gas connecting into the chamber.

22. The apparatus of claim 21 wherein the workpiece holder comprises a rotor for rotating the workpiece.

23. The apparatus of claim 21 with the aqueous liquid further including ammonium hydroxide.

24. Apparatus comprising:
(a) means for forming a layer of a heated aqueous liquid on the surface of a workpiece, with the aqueous liquid including a chelating agent;
(b) means for supplying ozone gas to the surface of the workpiece, where the ozone oxidizes contamination on the surface to clean the workpiece.

25. The apparatus of claim 24 further including means for heating the surface of the workpiece.
